(19) United States
(12) Patent Application Publication
(10) Pub. No.: US 2025/0191570 A1
(43) Pub. Date: Jun. 12, 2025

(54) APPARATUS AND METHOD FOR REDUCING BRAKE NOISE THROUGH ACTIVE NOISE CONTROL AND METHOD THEREOF

(71) Applicants: Hyundai Motor Company, Seoul (KR); Kia Corporation, Seoul (KR)

(72) Inventors: Jeong Kyu KIM, Suwon-Si (KR); Jae Keun HWANG, Hwaseong-Si (KR)

(73) Assignees: Hyundai Motor Company, Seoul (KR); Kia Corporation, Seoul (KR)

(21) Appl. No.: 18/635,950

(22) Filed: Apr. 15, 2024

(30) Foreign Application Priority Data
Dec. 12, 2023 (KR) 10-2023-0179558

(51) Int. Cl. G10K 11/178

(52) U.S. Cl. CPC G10K 11/17875; G10K 11/17821; G10K 2210/1282; G10K 2210/3047

(57) ABSTRACT

An apparatus for reducing brake noise, may include: a detection unit detecting vibration information causing brake noise generated in relation to a brake operation; a control unit operatively connected to the detection unit and predicting the brake noise generated in an interior of a vehicle based on the vibration information, and generates a noise cancelling signal including anti-phase with respect to the brake noise; a speaker unit receiving the noise canceling signal from the control unit, and outputting the noise canceling signal to the interior of the vehicle; and a microphone unit obtaining noise information from the interior of the vehicle and transmitting the noise information to the control unit.

### CROSS-REFERENCE TO RELATED APPLICATION(S)

The present application claims priority to Korean Patent Application No. 10-2023-0179558 filed on Dec. 12, 2023, the entire contents of which is incorporated herein for all purposes by this reference.

### BACKGROUND OF THE PRESENT DISCLOSURE

### Field of the Present Disclosure

The present disclosure relates to an apparatus for reducing brake noise through active noise control and a method thereof, and specifically to an apparatus for reducing brake noise through active noise cancelling and a method thereof.

### Description of Related Art

There are various types of noise generated by a vehicle. In particular, noise is generated in relation to a brake operation provided in the vehicle. Brake noise is a noise generated by being amplified by a resonance and transmission system between brake components when a friction material is pressed against a drum or disc during braking, which is one of the major factors for reducing ride comfort in vehicles.

However, it is very difficult to change the transmission system to improve noise during vehicle development, and in reality, the transmission system may be improved through changing brake components, or the like, but in the instant case, the development period is long and the improvement effect is limited.

Therefore, there is a need to develop a method that can reduce brake noise without changing the design of the components.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus for reducing brake noise through active noise control and method for reducing brake noise through active noise control technology.

According to an aspect of the present disclosure, an apparatus for reducing brake noise may include: a detection unit detecting vibration information causing brake noise generated in relation to a brake operation; a control unit operatively connected to the detection unit and predicting the brake noise generated in an interior of a vehicle based on the vibration information, and generating a noise canceling signal including an anti-phase with respect to the brake noise; a speaker unit receiving the noise canceling signal from the control unit, and outputting the noise canceling signal to the interior of the vehicle; and a microphone unit obtaining noise information from the interior of the vehicle and transmitting the noise information to the control unit.

In an exemplary embodiment of the present disclosure, the control unit may be set to tune the noise cancelling signal based on the noise information received from the microphone unit.

In an exemplary embodiment of the present disclosure, the noise information obtained by the microphone unit may be feedback information regarding noise generated in an interior of a vehicle after the brake noise is canceled at least once by the noise cancelling signal.

In an exemplary embodiment of the present disclosure, the detection unit may be provided in an amount corresponding to a plurality of wheels provided on a vehicle, and may be located in a transmission path of vibrations generated by a brake operation to detect the vibration information.

In an exemplary embodiment of the present disclosure, the speaker unit may include a first speaker unit including a plurality of speakers outputting sound within a first range, and a second speaker unit including a plurality of speakers outputting sound within a second range, higher than the sound within the first range.

In an exemplary embodiment of the present disclosure, the apparatus for reducing the brake noise may operate in a first control mode and in a second control mode based on vehicle speed, the first control mode may be a mode for controlling noise in a first frequency range, and the second control mode may be a mode for controlling noise in a second control frequency range, lower than the first frequency.

In an exemplary embodiment of the present disclosure, when the vehicle speed is equal to or greater than a reference speed, the control unit may be set to control the brake noise in the first control mode, and when the vehicle speed is lower than a reference speed, the control unit may be set to control the brake noise in the second control mode.

In an exemplary embodiment of the present disclosure, the noise in the first frequency range may include grinding noise, and the noise in the second frequency range may include creep noise.

In an exemplary embodiment of the present disclosure, the control may be set to output the noise cancelling signal by combining at least a part of the plurality of speakers included in the first speaker unit and at least a part of the plurality of speakers included in the second speaker unit, and may be set to combine different speakers for each of the first control mode and the second control mode.

In an exemplary embodiment of the present disclosure, the control may be set to output the noise cancelling signal using a part of speakers of the first speaker unit in the first control mode, and may be set to output the noise cancelling signal using all speakers of the first speaker unit in the second control mode.

In an exemplary embodiment of the present disclosure, when the vehicle speed is equal to or greater than a first reference speed and equal to or lower than a second reference speed, the control unit may be set to control the brake noise in the first control mode, and when the vehicle speed is lower than a first reference speed, the control unit may be set to control the brake noise in the second control mode.

In an exemplary embodiment of the present disclosure, when a brake is operated, and the brake noise control is performed in the first control mode or the second control mode and then the brake is not operated, the control unit may be set to maintain the first control mode or the second control mode for a reference time.

According to an aspect of the present disclosure, a method for reducing brake noise may include: detecting vibration information causing brake noise generated in relation to a brake operation; predicting the brake noise generated in an interior of a vehicle based on the vibration information; generating a noise canceling signal including anti-phase with respect to the predicted brake noise and outputting the brake noise through a speaker unit inside the vehicle; and obtaining noise information from the interior of the vehicle through a microphone inside the vehicle, and tuning the noise cancelling signal based on the noise information.

In an exemplary embodiment of the present disclosure, the noise information obtained through the microphone unit may be feedback information regarding noise generated in the interior of the vehicle after the brake noise is canceled at least once by the noise cancelling signal.

In an exemplary embodiment of the present disclosure, determining a first control mode and a second control mode based on vehicle speed may be further included, wherein the first control mode may be a mode for controlling noise in a first frequency range, and the second control mode may be a mode for controlling noise in a second frequency range, lower than the first frequency.

In an exemplary embodiment of the present disclosure, when the vehicle speed is greater than or equal to a reference speed, the first control mode may be determined, and when the vehicle speed is lower than a reference speed, the second control mode may be determined.

In an exemplary embodiment of the present disclosure, the speaker unit may include a first speaker unit including a plurality of speakers outputting sound within a first range and a second speaker unit including a plurality of speakers outputting sound within a second range, higher than the sound within the first range.

In an exemplary embodiment of the present disclosure, the noise cancelling signal may be output using a part of speakers of the first speaker unit in the first control mode, and noise cancelling signal may be output using all speakers of the first speaker unit in the second control mode.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF DRAWINGS

FIG. 1 is a diagram schematically showing a vehicle provided with an apparatus for reducing brake noise according to an exemplary embodiment of the present disclosure.

FIG. 2 is a diagram schematically illustrating a location in which a speaker unit is disposed in the vehicle shown in FIG. 1.

FIG. 3 is a flowchart of a method for reducing brake noise according to an exemplary embodiment of the present disclosure.

FIG. 4 is a flowchart of a control method of an apparatus for reducing brake noise according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, the present disclosure will be described in detail with reference to the accompanying drawings. In adding reference numerals to elements of each of the drawings, although the same elements are illustrated in other drawings, like reference numerals may refer to like elements. Since the present disclosure can make various changes and have various exemplary embodiments of the present disclosure, specific embodiments are illustrated in the drawings and described in detail. However, this is not intended to limit the present disclosure to specific embodiments, and should be understood to include all modifications, equivalents, and substitutes included in the spirit and scope of the present disclosure.

Terms such as “first,” “second,” and the like, may be used to describe various components, but the components should not be limited by the terms. These terms are only used for distinguishing one component from another component. For example, a first element may be termed a second element, and similarly, a second element may be termed a first element, without departing from the scope of the present disclosure. The term ‘and/or’ includes a combination of a plurality of related recited items or any one of a plurality of related recited items.

Terms used in the present application are only used to describe specific embodiments, and are not intended to limit the present disclosure. Singular expressions include plural expressions unless the context thereof is clearly dictated otherwise. In the present application, terms such as “comprise” or “having” are intended to designate that there is a feature, number, step, operation, component, part, or combination thereof described in the specification, but one or more other features It should be understood that it does not preclude the possibility of the presence or addition of numbers, steps, operations, components, parts, or combinations thereof.

Unless defined otherwise, all terms used herein, including technical or scientific terms, include the same meaning as commonly understood by one of ordinary skill in the art to which the present disclosure belongs. Terms such as those defined in commonly used dictionaries should be interpreted as having a meaning consistent with the meaning in the context of the related art, and unless explicitly defined in the present application, they should not be interpreted in an ideal or excessively formal meaning.

Hereinafter, various exemplary embodiments of the present disclosure will be described with reference to the drawings.

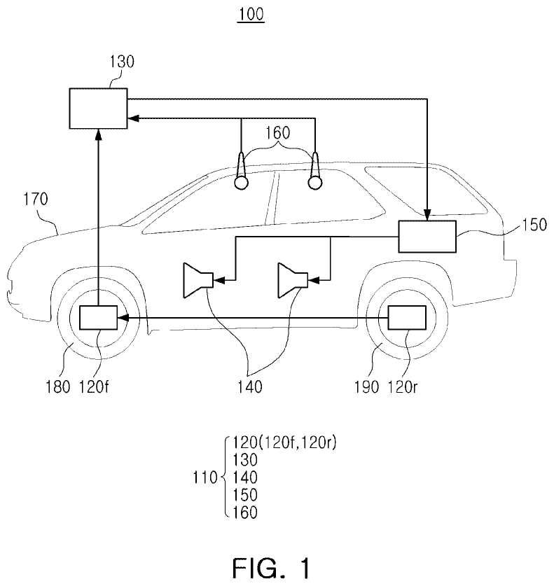

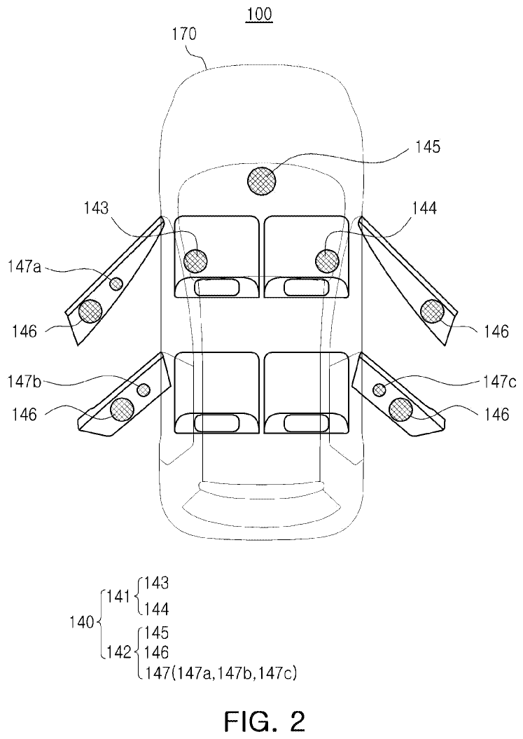

FIG. 1 is a diagram schematically illustrating a vehicle 100 provided with an apparatus 110 for reducing brake noise according to an exemplary embodiment of the present disclosure. FIG. 2 is a diagram schematically illustrating a location in which a speaker unit 140 is disposed in the vehicle 100 illustrated in FIG. 1.

The vehicle 100 according to an exemplary embodiment of the present disclosure may include an apparatus 110 for reducing brake noise (or a system for reducing brake noise), and may be provided to reduce noise in various frequency bands generated in relation to a vehicle brake operation based on active noise control (ANC). Hereinafter, ‘ANC’ is used as a term for a concept including Active Noise Canceling.

Referring to FIG. 1 and FIG. 2, a vehicle 100 according to various exemplary embodiments of the present disclosure may include an apparatus for reducing brake noise 110. The vehicle 100 may include a vehicle body 170, a front wheel 180 coupled to a front side of the vehicle body 170, and a rear wheel 190 coupled to a rear side of the vehicle body 170, and the apparatus 110 for reducing brake noise may be disposed on at least a portion of the vehicle body 170, the front wheel 180, and the rear wheel 190. For example, a plurality of components included in the apparatus 110 for reducing brake noise may be respectively provided in the vehicle body 170, front wheel 180, and rear wheel 190.

The apparatus 110 for reducing brake noise may include a detection unit 120, a control unit 130, a speaker unit 140, an amplifier unit 150, and a microphone unit 160.

The detection unit 120 may detect vibrations generated in relation to a brake operation of the vehicle 100. For example, the detection unit 120 may detect vibrations that can cause noise (e.g., brake noise) generated when the brake is operated (e.g., when the brake operated, when the brake is not operated, or when the brake is in a state of being operated). Hereinafter, ‘brake noise’ refers to noise generated due to the brake operation, and ‘brake vibrations’ refers to vibrations causing brake noise.

The detection unit 120 may detect vibrations causing brake noise and transmit the detected vibration signal to the control unit 130. The detection unit 120 may include an acceleration sensor or a vibration sensor. For example, the detection unit 120 may be implemented using a three-axis acceleration sensor configured for measuring acceleration in X-axis, Y-axis, and Z-axis directions. However, the type of the detection unit 120 is not limited to the sensors described above, and may be implemented using various sensors configured for detecting vibrations.

Meanwhile, the detection unit 120 is not limited to detecting vibrations related to a brake operation, and may detect various vibrations generated while the vehicle 100 is being driven. For example, the detection unit 120 may detect vibrations (e.g., road surface vibrations) causing road surface noise generated when a vehicle's tires are in contact with a road surface, and the vehicle 100 may be configured to reduce road surface noise based on road surface vibrations detected by the detection unit 120.

The detection unit 120 may be disposed in a location in which vibrations related to the brake operation, disposed on each wheel of the vehicle, may be detected. For example, the detection unit 120 may be located in a transmission path of brake vibrations and detect vibrations causing brake noise.

Four detection units 120 may be provided and may be mounted adjacent to four wheels. For example, the detection unit 120 may include two front wheel detection units 120f corresponding to two front wheels 180 and two rear wheel detection units 120r corresponding to two rear wheels 190. Each of the two front wheel side detection units 120f and the two rear wheel detection units 120r may be mounted near axles of the front wheel 180 and the rear wheel 190, or on a portion of the brake.

Meanwhile, the number of detection units 120 is not limited to four, and four or more detection units 120 may be provided. Furthermore, a mounting position of the detection unit 120 is not particularly limited and may be disposed in an optimal position to accurately detect brake vibrations, and such an optimal position may be determined through a simulation or test.

The control unit 130 is a component for controlling an overall operation of the apparatus for reducing the brake noise 110, a logic required for the operation of the apparatus 110 for reducing brake noise may be stored in the control unit 130, and various decisions may be made according to the logic described above to generate or transmit control signals or commands. For example, the control unit 130 may be referred to as a control unit (digital signal processor (DSP) for acoustic signal analysis.

The control unit 130 may include a processor and memory. Here, the processor is configured for controlling an overall operation of the controller, and the memory may store programs for the operation of the controller, input/output data, various setting information, and the like. The memory may be implemented with one or more storage media such as flash memory, hard disk, Secure Digital (SD) Card, Random Access Memory (RAM), Read Only Memory (ROM), web storage, and the like.

The control unit 130 may receive brake vibrations information detected by the detection unit 120. The control unit 130 may be configured to predict brake noise flowing to the interior of the vehicle 100 based on brake vibration information obtained from the detection unit 120.

The control unit 130 may be configured to generate a sound wave (e.g., a control signal for noise cancelling) having a phase opposite thereto (e.g., in anti-phase) based on the predicted brake noise, and output or radiate a sound wave having anti-phase to the interior of the vehicle 100 through a speaker unit 140. As described above, when the sound wave in the anti-phase is propagated to the interior of the vehicle 100, the sound wave may meet brake noise and cancel the brake noise.

The control unit 130 may obtain noise information generated in the interior of the vehicle 100 in real time through a microphone unit 160 provided inside the vehicle 100 to confirm whether brake noise is reduced, and using the noise information, the control unit 130 may continuously tune anti-phase sound waves and provide feedback control to reduce noise.

The speaker unit 140 may be provided inside the vehicle 100 and may output a predetermined audio signal or audio wave signal based on the control of the control unit 130. For example, the speaker unit 140 may output a control signal for noise cancellation (e.g., a noise cancelling signal) applied from the control unit 130.

Referring to FIG. 2, the speaker unit 140 may be comprised of a plurality of speaker devices 141 and 142 and mounted on each portion of the vehicle 100. The speaker unit 140 may include a plurality of first speaker units 141 outputting sound within a first range and a plurality of second speaker units 142 outputting sound within a second range, higher than the sound within the first range. For example, the first speaker unit 141 may be responsible for a low-pitch range, and the second speaker unit 142 may be responsible for a mid/high-pitch range.

The plurality of first speaker units 141 may include a first speaker 143 and a second speaker 144 disposed on a front seat of the vehicle 100. For example, the first speaker 143 and the second speaker 144 may include a woofer speaker or a subwoofer speaker. The first speaker 143 and the second speaker 144 may be the same type of speaker or may be different types of speakers.

The plurality of second speaker units 142 may include a third speaker 145 disposed on a front side of the vehicle 100, four fourth speakers 146 respectively disposed on four doors of the vehicle 100, and a fifth speaker 147 located in at least a portion of the four doors of the vehicle 100. The fifth speaker 147 may include a first sub speaker 147a disposed on a front left door of the vehicle 100, a second sub speaker 147b disposed on a rear left door of the vehicle 100, and a third sub speaker 147c disposed on a rear right door of the vehicle 100. For example, the third speaker 145, the fourth speaker 146, and the fifth speaker 147 may include a mid-range speaker or a tweaker speaker. The third speaker 145, the fourth speaker 146, and the fifth speaker 147 may be the same type of speaker or may be different types of speakers.

When the apparatus 110 for reducing brake noise operates, the speaker unit 140 may have different speaker devices for outputting a noise canceling signal based on the type of brake noise, that is, a frequency range of the brake noise. The speaker device used to output the noise cancelling signal may be determined based on the control of the control unit 130.

Meanwhile, the arrangement of the speaker unit 140 illustrated in FIG. 2 and the type/component of the speaker unit 140 described with reference to FIG. 2 are exemplary and are not limited thereto. According to various exemplary embodiments of the present disclosure, the speaker unit 140 may include a low-pitched range speaker, a mid-pitched speaker, and a high-pitched range speaker, or may be provided to output sounds of different pitch ranges, by including a low-pitched range speaker and a mid/high-pitched range speaker.

The amplifier unit 150 may receive a control signal for noise cancellation from the control unit 130 and amplify the control signal. The control signal amplified by the amplifier unit 150 may be transmitted to the speaker unit 140 and output through the speaker unit 140. The amplifier unit 150 may be electrically connected to the control unit 130 and the speaker unit 140 to transmit and receive of signals. For example, the control unit 130 may be configured to generate a noise canceling signal having an opposite phase to the brake noise, and transmit the generated noise canceling signal to the amplifier unit 150 and amplify the signal, and the noise canceling signal amplified by the amplifier unit 150 may be output through the speaker unit 140.

The microphone unit 160 may be provided to the interior of a vehicle 100 and may measure noise inside the vehicle 100. The microphone unit 160 may monitor noise information generated in the interior of the vehicle 100 in real time and transmit the noise information to the control unit 130. For example, the microphone unit 160 may monitor a level of noise generated in the interior of the vehicle 100 by measuring noise transmitted to occupants of the vehicle 100.

The noise information monitored by the microphone unit 160 may mean the level of noise generated in the interior of the vehicle 100 after the noise canceling signal is output through the speaker unit 140. For example, the microphone unit 160 may measure the noise after the brake noise has been at least partially canceled by the noise cancelling signal and transmit the noise to the control unit 130, and the control unit 130 may perform feedback control to tune the noise cancelling signal based on the noise cancelling signal based on the noise information provided from the microphone unit 160.

The microphone unit 160 may be comprised of a plurality of microphone devices and may be mounted at various locations inside the vehicle 100. The number of microphone devices including the microphone unit 160 and the positions thereof are not limited, and may be provided in various locations and in various numbers to measure/monitor noise generated in the interior of the vehicle 100.

The apparatus for reducing the brake noise according to an exemplary embodiment of the present disclosure may operate by distinguishing control modes based on vehicle speed. Brake noise may include noise in a first frequency range and noise in a second frequency range, lower than the first frequency. When noise in the first frequency range is generated, the control unit 130 may operate the apparatus 110 for reducing brake noise in the first control mode, and when the noise in the second frequency range is generated, the control unit 130 may operate the apparatus 110 for reducing brake noise in the second control mode.

For example, brake noise in the first frequency range may refer to grinding noise, which is noise in a range of about 100 Hz to 300 Hz, and brake noise in the second frequency range may refer to creep noise (e.g., creep groan noise), noise in a bandwidth below about 100 Hz, but is not necessarily limited thereto.

The conditions for generating noise in the first frequency range and the conditions for generating noise in the second frequency range may be determined by the speed of the vehicle 100. When the speed of the vehicle 100 is equal to or greater than a reference speed after the brake is operated, noise in the first frequency range may be generated, and when the speed of the vehicle 100 is lower than the reference speed, noise in the second frequency range may be generated. For example, the noise in the first frequency range, which is a relatively high frequency, may be generated when the speed of the vehicle 100 is relatively fast, and the noise in the second frequency range, which is a relatively low frequency, may be generated when the speed of the vehicle 100 is relatively slow. The reference speed may have various values depending on the type of vehicle 100, and may be set in advance and stored in the control unit 130.

According to various exemplary embodiments of the present disclosure, the condition for generating noise in the first frequency range may further include an upper limit condition for speed. After a brake is operated, when the speed of the vehicle 100 is equal to or greater than a first reference speed and equal to or lower than a second reference speed, noise in a first frequency range may be generated, and when the speed is less than the first reference speed, noise in a second frequency range may be generated. For example, the first reference speed may be about 3 km/h, and the second reference speed may be about 23 km/h, but the present disclosure is not limited thereto.

The control unit 130 may be set to output a noise cancelling signal through different speakers in the first control mode and the second control mode. Based on the fact that noise control in the mid/high-pitch range is required in the first control mode and noise control in the low-pitch range is required in the second control mode, the control unit 130 may output a noise cancelling signal using a speaker among the speaker units 140, corresponding thereto.

The number of first speaker units 141 used in the first control mode may be less than the number of second speaker units 142 used in the second control mode. In the first control mode, the control unit 130 may output a control signal using one speaker of the first speaker units 141 and at least a portion of the remaining speakers of the second speaker units 142. Furthermore, in the second control mode, the control unit 130 may output a control signal using all speakers of the first speaker units 141 and at least a portion of the remaining speakers of the second speaker units 142.

For example, in the first control mode, the noise canceling signal may be output through eight speakers including a first speaker 143 of the first speaker units 141, a third speaker 145 of the second speaker units 142, four fourth speakers 146, a second sub-speaker 147b, and a third sub-speaker 147c. Furthermore, for example, in the second control mode, the noise canceling signal may be output through eight speakers including all of the first speaker units 141 (the first speaker 143 and the second speaker 144), the third speaker 145 of the second speaker units 142, the four fourth speakers 145, and the first sub-speaker 147a. However, the speakers used are illustrative and are not particularly limited.

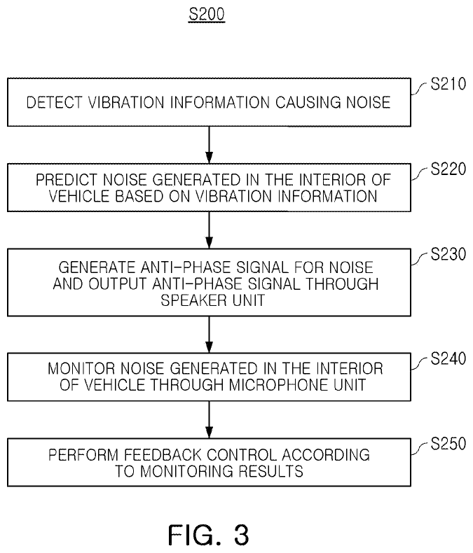

FIG. 3 is a flowchart of a method for reducing brake noise (S200) according to an exemplary embodiment of the present disclosure.

The method for reducing brake noise (S200) of FIG. 3 may be a method in which the vehicle 100 provided with the apparatus 110 for reducing brake noise described with reference to FIG. 1 and FIG. 2.

At least a portion of the operations included in the method for reducing brake noise (S200) may be performed by at least a portion of the components included in the apparatus 110 for reducing brake noise (e.g., the detection unit 120, control unit 130, speaker unit 140, amplifier unit 150, and microphone unit 160 of FIG. 1 and FIG. 2).

Hereinafter, in describing FIG. 3, FIG. 1 and FIG. 2 will be referred to together and overlapping description thereof will be omitted.

Referring to FIG. 3, the method for reducing brake noise (S200) according to various exemplary embodiments of the present disclosure may include detecting vibrations information causing noise (S210), predicting noise generated in an interior of a vehicle based on vibrations information (S220), generating an anti-phase sound wave signal for the predicted noise and outputting the anti-phase sound wave signal through the speaker unit (S230), and monitoring noise generated in the vehicle through a microphone unit (S240), and performing feedback control according to the monitoring results (S250).

In the operation of detecting vibrations information causing noise (S210), the detection unit 120 may detect brake vibrations causing brake noise introduced into or generated in the interior of the vehicle 100. The detection unit 120 may detect the detected brake vibrations to the control unit 130.

In the operation of predicting noise generated in the interior of the vehicle based on vibration information (S220), the control unit 130 may be configured to predict brake noise introduced into or generated in the interior of the vehicle 100 based on brake vibrations obtained through the detection unit 120. For example, the control unit 130 may be configured to determine brake noise by analyzing the brake vibrations received by the detection unit 120.

In the operation of generating an anti-phase sound wave signal for the predicted noise and the anti-phase sound wave signal through a speaker unit (S230), the control unit 130 may be configured to generate a noise cancelling signal, a sound wave signal having a frequency in anti-phase with respect to the predicted brake noise, and the generated noise cancelling signal may be output to the interior of the vehicle 100 through the speaker unit 140. At least a portion of the brake noise may be canceled due to the output of the noise cancelling signal.

In the operation (S230), a noise canceling signal may be amplified by the amplifier unit 150, and the noise canceling signal amplified by the amplifier unit 150 may be output by the speaker unit 140.

In the operation of monitoring noise generated in the interior of the vehicle 100 through the microphone unit (S240), the microphone unit 160 provided inside the vehicle 100 may monitor and measure noise information inside the vehicle 100 in real time, and transmit the measured noise information to the control unit 130. The noise information measured through the microphone unit 160 may be used to tune a noise cancelling signal for feedback control.

In the operation of performing feedback control according to the monitoring results (S250), based on the noise information generated in the interior of the vehicle 100 received from the microphone unit 160, the control unit 130 may tune the noise cancelling signal to cancel the noise information. For example, the control unit 130 may receive noise generated in the interior of the vehicle 100 after being cancelled by the output of the noise cancelling signal in the operation S230, continuously tune the noise cancelling signal to include an anti-phase to cancel the noise, and perform feedback control for outputting the tuned noise cancelling signal. Accordingly, the performance of cancelling and reducing brake noise may be increased.

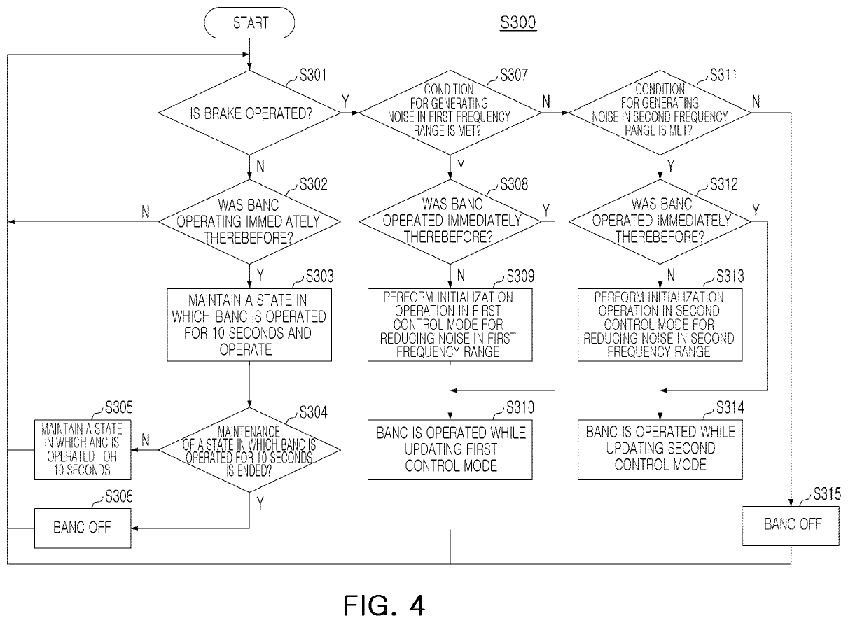

FIG. 4 is a flowchart of a control method (S300) of an apparatus 110 for reducing brake noise according to an exemplary embodiment of the present disclosure.

FIG. 4 is a flowchart for illustrating a control method in which the apparatus for reducing the brake noise 100 classifies a frequency range of brake noise based on a speed of a vehicle 100, and is configured to control noise based the speed of the vehicle 100, and may be an overall control method including the method for reducing brake noise (S300) described in FIG. 3.

The control method (S300) illustrated in FIG. 4 may be performed by at least a portion of the components of the apparatus 110 for reducing brake noise of FIG. 1 and FIG. 2, and overlapping descriptions thereof will be omitted below.

Referring to FIG. 4, the apparatus 110 for reducing brake noise according to various exemplary embodiments of the present disclosure may be configured to determine whether a condition for generating noise in a first frequency range is met or a condition for generating noise in a second frequency range, lower than the first frequency based on the speed of the vehicle is met, and operate by dividing a control mode based thereon. In FIG. 4, BANC refers to Brake-noise Active Noise Control, and BANC operation means that the apparatus 110 for reducing brake noise operates to perform noise control.

The apparatus for reducing the brake noise may be configured to determine whether the vehicle is currently in a state in which a brake of the vehicle is operated (S301).

When the brake is not operated, the apparatus for reducing the brake noise may be configured to determine whether BANC was operated immediately therebefore (S302).

When the BANC operates, an operating state may be maintained for a reference time (e.g., about 10 seconds) (S303), and when the BANC does not operate, the operation S301 may be performed again. Here, the reference time is illustrative and is not limited to 10 seconds.

Thereafter, it may be determined whether the operation of BANC is maintained for a reference time (S304). When the operation of BANC is maintained for the reference time, BANC may not operate (stops operation) (S305), and when the operation of BANC is less than the reference time, the operation of BANC may be maintained until the reference time (S306).

When the brake is operated, the apparatus for reducing the brake noise may be configured to determine whether a condition for generating noise in a first frequency range is met (S307). For example, when the speed of the vehicle is equal to or greater than a reference speed (e.g., about 3 km/h), the control unit of the apparatus for reducing the brake noise may be configured to determine that the condition for generating noise in a first frequency range is met. Here, the noise in the first frequency range is brake noise in a relatively high frequency band, and may be, for example, grinding noise.

When the condition for generating noise in the first frequency range is met, the apparatus for reducing the brake noise may be configured to determine whether BANC was operated to cancel the noise in the first frequency range immediately therebefore (S308). For example, it may be determined whether the apparatus for reducing the brake noise operates in the first control mode.

When the BANC does not operate, a mode of the apparatus for reducing the brake noise as a first control mode corresponding to the noise in the first frequency range and operate in the corresponding mode (S309). For example, the first control mode may operate to output a noise canceling signal for noise control in the mid/high-pitch range.

When the BANC operates, the first control mode may be updated by monitoring the noise generated in the interior of the vehicle specified by the microphone unit and tuning the noise cancelling signal based on the monitoring result (S310). For example, the operation method of S200 illustrated in FIG. 3 may be performed in operations S308 to S310.

When the condition for generating noise in the first frequency range is not met, the apparatus for reducing the brake noise may be configured to determine whether the condition for generating noise in the second frequency range is met (S311). For example, when the vehicle speed is lower than a reference speed (e.g., about 3 km/h), the control unit of the apparatus for reducing the brake noise may be configured to determine that the condition for generating noise in the second frequency range is met. Here, the noise in the second frequency range is brake noise in a relatively low frequency band, and may be, for example, creep noise.

When the condition for generating noise in the second frequency range is met, it may be determined whether the BANC was operated to cancel the noise in the second frequency range immediately therebefore (S312). For example, it may be determined whether the apparatus for reducing the brake noise operates in the second control mode.

When BANC does not operate, a mode of the apparatus for reducing the brake noise may be determined as a second control mode corresponding to noise in the second frequency range and operated in the corresponding mode (S313). For example, the second control mode may operate to output a noise canceling signal for noise control in the low-pitch range.

When the BANC operates, the second control mode may be updated by monitoring the noise generated in the interior of the vehicle specified by the microphone unit and tuning the noise canceling signal based on the monitoring results (S314). For example, the operation method of S200 illustrated in FIG. 3 may be performed in operations S312 to S314.

When the condition for generating noise in the second frequency range is not met in operation S311, BANC may be turned off (stopped) when BANC is operated (S315). The operation S301 may be performed when BANC is not operated.

As set forth above, according to an exemplary embodiment of the present disclosure, brake noise may be canceled through active noise control, and a noise canceling effect may be increased through feedback control.

Furthermore, according to an exemplary embodiment of the present disclosure, the noise canceling effect may be increased by dividing a control mode according to a frequency range of the brake noise and varying a speaker used for output.

The aforementioned description merely illustrates the technical concept of the present disclosure, and a person skilled in the art to which an exemplary embodiment of the present disclosure pertains may make various modifications and modifications without departing from the essential characteristics of the present disclosure.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for reducing brake noise by brake noise control, the apparatus comprising:
a detection unit detecting vibration information causing brake noise generated in relation to a brake operation of a vehicle;
a control unit operatively connected to the detection unit and predicting the brake noise generated in an interior of the vehicle based on the vibration information, and generating a noise cancelling signal having anti-phase with respect to the brake noise;
a speaker unit operatively connected to the control unit and receiving the noise canceling signal from the control unit, and outputting the noise canceling signal to the interior of the vehicle; and
a microphone unit operatively connected to the control unit and obtaining noise information from the interior of the vehicle and transmitting the noise information to the control unit.

2. The apparatus of claim 1, wherein the control unit is configured to tune the noise canceling signal based on the noise information received from the microphone unit.

3. The apparatus of claim 1, wherein the noise information obtained by the microphone unit is feedback information regarding noise generated in the interior of the vehicle after the brake noise is canceled at least once by the noise cancelling signal.

4. The apparatus of claim 1, wherein the detection unit is provided in an amount corresponding to a plurality of wheels provided on the vehicle, and is located in a transmission path of vibrations generated by the brake operation, to detect the vibration information.

5. The apparatus of claim 1, wherein the speaker unit includes:
a first speaker unit including a plurality of speakers outputting sound within a first range; and
a second speaker unit including a plurality of speakers outputting sound within a second range, higher than the sound within the first range.

6. The apparatus of claim 5,
wherein the apparatus for reducing the brake noise operates in a first control mode and a second control mode,
wherein the first control mode is a mode for controlling noise in a first frequency range, and
wherein the second control mode is a mode for controlling noise in a second frequency range, lower than the first frequency.

7. The apparatus of claim 6,
wherein in response that the vehicle speed is higher than a reference speed, the control unit is configured to control the brake noise in the first control mode, and wherein in response that the vehicle speed is lower than the reference speed, the control unit is configured to control the brake noise in the second control mode.

8. The apparatus of claim 6,
wherein the noise in the first frequency range includes grinding noise, and
wherein the noise in the second frequency range includes creep noise.

9. The apparatus of claim 6,
wherein the control unit is configured to output the noise cancelling signal by combining at least a part of the plurality of speakers included in the first speaker unit and at least a part of the plurality of speakers included in the second speaker unit, and
wherein the control unit is configured to combine different speakers for each of the first control mode and the second control mode.

10. The apparatus of claim 6,
wherein the control unit is configured to output the noise cancelling signal by use of a part of speakers of the first speaker unit in the first control mode, and
wherein the control unit is configured to output all speakers of the first speaker unit in the second control mode.

11. The apparatus of claim 7,
wherein in response that the vehicle speed is greater than or equal to a first reference speed and equal to or lower than a second reference speed, the control unit is configured to control the brake noise in the first control mode, and
wherein in response that the vehicle speed is lower than the first reference speed, the control unit is configured to control the brake noise in the second control mode.

12. The apparatus of claim 6, wherein in response that a brake of the vehicle is operated and the brake noise control is performed in the first control mode or the second control mode and then the brake is not operated,
the control unit is configured to maintain the first control mode or the second control mode for a reference time.

13. A method for reducing brake noise by brake noise control, the method comprising:
detecting vibration information causing brake noise generated in relation to a brake operation;
predicting, by a control unit, the brake noise generated in an interior of a vehicle based on the vibration information;
generating, by the control unit, a noise canceling signal having anti-phase with respect to the predicted brake noise and outputting the noise cancelling signal through a speaker unit inside the vehicle; and
obtaining, by the control unit, noise information from the interior of the vehicle through a microphone unit inside the vehicle, and tuning the noise cancelling signal based on the noise information.

14. The method of claim 13, wherein the noise information obtained by the microphone unit is feedback information regarding the noise generated in the interior of the vehicle after the brake noise is canceled at least once by the noise cancelling signal.

15. The method of claim 13, further including:
determining, by the control unit, a first control mode and a second control mode based on vehicle speed,
wherein the first control mode is a mode for controlling noise in a first frequency range, and
wherein the second control mode is a mode for controlling noise in a second frequency range, lower than the first frequency.

16. The method of claim 15,
wherein in response that the vehicle speed is greater than or equal to a reference speed, the first control mode is determined, and
wherein in response that the vehicle speed is lower than the reference speed, the second control mode is determined.

17. The method of claim 15, wherein the speaker unit includes a first speaker unit including a plurality of speakers outputting sound within a first range and a second speaker unit including a plurality of speakers outputting sound within a second range, higher than the sound within the first range.

18. The method of claim 17,
wherein the noise cancelling signal is output using a part of speakers of the first speaker unit in the first control mode, and
wherein the noise cancelling signal is output using all speakers of the first speaker unit in the second control mode.

19. The method of claim 15,
wherein in response that the vehicle speed is greater than or equal to a first reference speed and equal to or lower than a second reference speed, the control unit is configured to control the brake noise in the first control mode, and
wherein in response that the vehicle speed is lower than the first reference speed, the control unit is configured to control the brake noise in the second control mode.

20. The method of claim 15, wherein in response that a brake of the vehicle is operated and the brake noise control is performed in the first control mode or the second control mode and then the brake is not operated,
the control unit is configured to maintain the first control mode or the second control mode for a reference time.
